(19) United States
(12) Patent Application Publication
(10) Pub. No.: US 2024/0340149 A1
(43) Pub. Date: Oct. 10, 2024

(54) METHOD AND APPARATUS FOR PUCCH RESOURCE CONFIGURATION FOR MULTICAST SERVICE

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/294,402

(22) PCT Filed: Aug. 3, 2021
(86) PCT No.: PCT/CN2021/110300

§ 371 Date: Feb. 1, 2024

(51) Int. Cl. H04L 5/00; H04L 1/1829

(52) U.S. Cl. CPC H04L 5/0055; H04L 1/1864; H04L 5/0094

(57) ABSTRACT

Embodiments of the present disclosure relate to physical uplink control channel (PUCCH) resource configuration. According to some embodiments of the disclosure, a method performed by a user equipment (UE) may include: receiving configuration information of a PUCCH resource pool for a group of UEs receiving a multicast transmission, wherein the group of UEs comprises the UE; and receiving a hybrid automatic repeat request acknowledgement (HARQ-ACK) feedback mode indication, wherein the HARQ-ACK feedback mode indication indicates a HARQ-ACK feedback mode for the multicast transmission from a plurality of HARQ-ACK feedback modes; and determining, based on the indicated HARQ-ACK feedback mode, a PUCCH resource from the PUCCH resource pool for transmitting HARQ-ACK feedback for the multicast transmission.

### TECHNICAL FIELD

Embodiments of the present disclosure generally relate to wireless communication technology, and more particularly to physical uplink control channel (PUCCH) resource configuration for a multicast service.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

A wireless communication system may support multicast and broadcast services (MBSs). One or more user equipment (UE) may be grouped as an MBS group and may receive multicast transmissions from a base station (BS) via a physical downlink shared channel (PDSCH). The one or more UEs may transmit hybrid automatic repeat request acknowledgement (HARQ-ACK) feedback corresponding to the PDSCH transmission through a physical uplink control channel (PUCCH) or a physical uplink shared channel (PUSCH).

There is a need for handling HARQ-ACK feedback and PUCCH resource configuration for multicast transmissions in a wireless communication system.

### SUMMARY

Some embodiments of the present disclosure provide a method for wireless communication performed by a user equipment (UE). The method may include: receiving configuration information of a physical uplink control channel (PUCCH) resource pool for a group of UEs receiving a multicast transmission, wherein the group of UEs comprises the UE; and receiving a hybrid automatic repeat request acknowledgement (HARQ-ACK) feedback mode indication, wherein the HARQ-ACK feedback mode indication indicates a HARQ-ACK feedback mode for the multicast transmission from a plurality of HARQ-ACK feedback modes; and determining, based on the indicated HARQ-ACK feedback mode, a PUCCH resource from the PUCCH resource pool for transmitting HARQ-ACK feedback for the multicast transmission.

Some embodiments of the present disclosure provide a method for wireless communication performed by a base station (BS). The method may include: transmitting, to a group of UEs receiving a multicast transmission, configuration information of a physical uplink control channel (PUCCH) resource pool; determining, from a plurality of hybrid automatic repeat request acknowledgement (HARQ-ACK) feedback modes, a HARQ-ACK feedback mode for the multicast transmission; transmitting, to the group of UEs, a HARQ-ACK feedback mode indication indicating the HARQ-ACK feedback mode; and determining, based on the HARQ-ACK feedback mode, a PUCCH resource from the PUCCH resource pool for receiving HARQ-ACK feedback for the multicast transmission from a UE of the group of UEs.

Some embodiments of the present disclosure provide a method for wireless communication performed by a user equipment (UE). The method may include: receiving configuration information of a UE-specific physical uplink control channel (PUCCH) resource set, wherein the UE-specific PUCCH resource set is from a plurality of PUCCH resource sets which are configured for a group of UEs receiving a multicast transmission, and wherein the group of UEs comprises the UE; receiving a PUCCH resource indication, wherein the PUCCH resource indication indicates a PUCCH resource from the UE-specific PUCCH resource set; and determining, based on the PUCCH resource indication, a PUCCH resource from the UE-specific PUCCH resource set for transmitting hybrid automatic repeat request acknowledgement (HARQ-ACK) feedback for the multicast transmission.

Some embodiments of the present disclosure provide a method for wireless communication performed by a base station (BS). The method may include: determining a plurality of physical uplink control channel (PUCCH) resource sets for a group of UEs receiving a multicast transmission; transmitting, to a UE of the group of UEs, a UE-specific PUCCH resource set selected from the plurality of PUCCH resource sets; transmitting, to the UE of the group of UEs, a PUCCH resource indication indicating a PUCCH resource from the UE-specific PUCCH resource set; and determining, based on the PUCCH resource indication, a PUCCH resource from the UE-specific PUCCH resource set for receiving hybrid automatic repeat request acknowledgement (HARQ-ACK) feedback for the multicast transmission.

Some embodiments of the present disclosure provide a UE. According to some embodiments of the present disclosure, the UE may include: a transceiver; and a processor coupled to the transceiver, wherein the transceiver and the processor may interact with each other so as to perform a method according to some embodiments of the present disclosure.

Some embodiments of the present disclosure provide a BS. According to some embodiments of the present disclosure, the BS may include: a transceiver; and a processor coupled to the transceiver, wherein the transceiver and the processor may interact with each other so as to perform a method according to some embodiments of the present disclosure.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of wireless communications in accordance with some embodiments of the present disclosure;

FIG. 3 illustrates a flow chart of an exemplary procedure of wireless communications in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

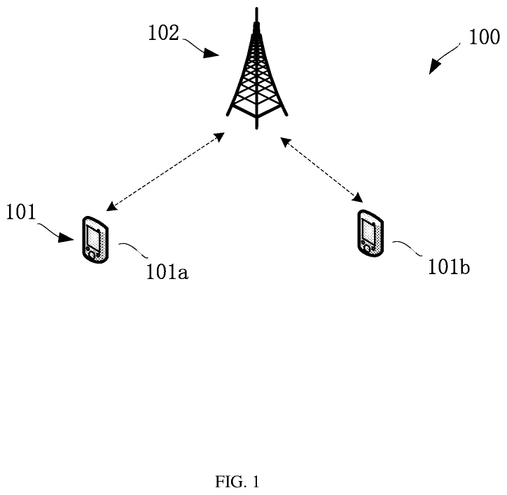

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, the wireless communication system 100 may support multicast and broadcast services (MBSs). For example, one or more UEs (e.g., UE 101a and UE 101b) may be grouped as an MBS group to receive MBSs (e.g., an MBS PDSCH) from a BS (e.g., BS 102). Several transmission schemes including, but not limited to, the following three transmission schemes may be applied for multicast transmission: a point-to-point (PTP) transmission scheme, point-to-multipoint (PTM) transmission scheme 1, and PTM transmission scheme 2.

Under the PTP transmission scheme, RRC_CONNECTED UEs may use a UE-specific PDCCH with a cyclic redundancy check (CRC) scrambled by a UE-specific radio network temporary identifier (RNTI) (e.g., cell-RNTI (C-RNTI)) to schedule a UE-specific PDSCH which is scrambled by the same UE-specific RNTI.

Under PTM transmission scheme 1, RRC_CONNECTED UEs in the same MBS group may use a group-common PDCCH with a cyclic redundancy check (CRC) scrambled by a group-common radio network temporary identifier (RNTI) to schedule a group-common PDSCH which is scrambled by the same group-common RNTI. This scheme may also be referred to as a group-common PDCCH based group scheduling scheme. The group-common RNTI may be configured via RRC signaling.

Under PTM transmission scheme 2, RRC_CONNECTED UEs in the same MBS group may use a UE-specific PDCCH with a CRC scrambled by a UE-specific RNTI (e.g., cell-RNTI) to schedule a group-common PDSCH which is scrambled by a group-common RNTI. This scheme may also be referred to as a UE-specific PDCCH based group scheduling scheme.

The “group-common PDCCH/PDSCH” may mean that the PDCCH or PDSCH is transmitted in a common time and/or frequency resources, and can be identified by all the UEs in the same MBS group. The “UE-specific PDCCH/PDSCH” may mean that the PDCCH or PDSCH can only be identified by the target UE, but cannot be identified by other UEs.

A UE receiving a downlink multicast transmission may transmit HARQ-ACK feedback corresponding to the downlink multicast transmission to the BS through, for example, a physical uplink control channel (PUCCH). The HARQ-ACK feedback corresponding to downlink multicast transmission is essential for the multicast services in order to satisfy a quality of service (QOS) requirement, such as reliability. In some embodiments of the present disclosure, a group-common RNTI (e.g., group-RNTI (G-RNTI)) is introduced for an MBS so that a UE can differentiate a downlink control information (DCI) format scheduling an MBS PDSCH from a DCI format scheduling a unicast PDSCH. For example, the CRC of the DCI scheduling an MBS PDSCH may be scrambled by the G-RNTI and the scheduled group-common PDSCH carrying the MBS may also be scrambled by the G-RNTI.

Several options including, but not limited to, the following three options may be applied for HARQ-ACK feedback transmission corresponding to a PDSCH carrying multicast service: (1) Group NACK-only transmission, (2) UE-specific NACK-only transmission, and (3) UE-specific ACK/NACK transmission. The descriptions of the three options are listed below:
Option (1): Group NACK-only transmission
   A UE does not transmit an acknowledgement (ACK) to the BS when a PDSCH is successfully received.
   The UE transmits a negative ACK (NACK) to the BS when the PDSCH is not successfully received.
   A group of UEs share the same resource to transmit respective NACK(s), if any.
Option (2): UE-specific NACK-only transmission
   A UE does not transmit an ACK to the BS when a PDSCH is successfully received.
   The UE transmits a NACK to the BS when the PDSCH is not successfully received.
   Each UE of the group of UEs is provided with a specific PUCCH resource for the corresponding UE to transmit a respective NACK (if any) to the BS.
Option (3): UE-specific ACK/NACK transmission
   A UE transmits an ACK to the BS when a PDSCH is successfully received.
   A UE transmits a NACK to the BS when the PDSCH is not successfully received.
   Each UE of the group of UEs is provided with a specific PUCCH resource for the corresponding UE to transmit a respective ACK/NACK to the BS.

Among the above three options, compared to Option (1), Option (2) and Option (3) can support PTP based retransmission for a relatively high QoS. Option (1) can minimize PUCCH resource overhead while the BS cannot differentiate which UE of the group of UEs transmits the NACK in the shared PUCCH resource and cannot support PTP based retransmission. From a UE's perspective, when it is configured with Option (1), the UE does not expect to receive a DCI with a CRC scrambled by a UE-specific RNTI (e.g., C-RNTI) for scheduling the retransmission of a TB which is initially transmitted in PTM scheme 1. Option (2) can support PTP based retransmission at the cost of increased PUCCH resources. Both Option (1) and Option (2) may require a relatively significant standardization effort.

Compared to Option (1) and Option (2), Option (3) may have a relatively minor standardization effort based on an existing HARQ-ACK codebook determination and the BS can differentiate an ACK or NACK from a corresponding UE at the cost of a UE-specific PUCCH resource reservation. However, when a large number of UEs (e.g., several hundreds of UEs) are receiving the multicast transmission, since the HARQ-ACK feedback timing indicator is transmitted in the group-common PDCCH, it implies that all the receiving UEs shall transmit the UE-specific ACK/NACK feedback in the same slot. Since two UE-specific PUCCH resources may be required for each UE to transmit an ACK and a NACK corresponding to the multicast transmission, such UE-specific ACK/NACK feedback will consume too many PUCCH resources. Assuming there are N UEs in the multicast group for receiving the multicast transmission, then 2×N orthogonal PUCCH resources are required in one slot for UE-specific ACK/NACK feedback. In that sense, the PUCCH resources may be exhausted especially when significant PUCCH resources are also required to be reserved for unicast PDSCH transmissions and a long PUCCH (e.g., PUCCH format 1) is required for UL coverage for feedback to multicast.

Embodiments of the present disclosure provide solutions to adjust the scarcity of the PUCCH resources. For example, in some embodiments of the present disclosure, a wireless system may support the enabling and disabling of HARQ-ACK feedback based on, for example, the number of UEs joining the multicast group or the number of available PUCCH resources for supporting UE-specific ACK/NACK feedback. In some examples, the enabling/disabling of the ACK/NACK-based HARQ-ACK feedback may be implemented as follows. Radio resource control (RRC) signaling may be used to configure an enabling/disabling function of a group-common DCI, which may indicate the enabling/disabling of the ACK/NACK based HARQ-ACK feedback. For instance, when RRC signaling configures the function of a group-common DCI based indication, a group-common DCI may indicate (explicitly or implicitly) whether ACK/NACK based HARQ-ACK feedback is enabled or disabled at a UE. Otherwise, the enabling/disabling of the ACK/NACK based HARQ-ACK feedback may be configured by RRC signaling.

In some embodiments of the present disclosure, a finer adjustment is provided. For example, in view of the aforementioned three HARQ-ACK feedback options, a better way to solve the problem is to dynamically adjust the adopted HARQ-ACK feedback options.

In some embodiments of the present disclosure, the HARQ-ACK feedback options may be dynamically adjusted based on, for example, QoS requirements, the number of UEs in a multicast group, the number of available PUCCH resources, or any combination thereof. This is beneficial because the number of UEs in a multicast group may be variable from time to time. For example, some UEs may leave the group and some new UEs may join the group at any time, which causes the number of UEs in the multicast group to vary. Moreover, since the number of available PUCCH resources may be predetermined, the variable number of UEs in a multicast group may require a dynamic HARQ-ACK feedback option. For example, when the QoS is not high, the BS can disable the HARQ-ACK feedback. Otherwise, when the QoS is relatively high, the BS can adopt one of Option (1), Option (2) and Option (3) based on, for example, the number of UEs in a multicast group and the number of available PUCCH resources.

However, since a multicast PDSCH is scheduled by a group-common PDCCH, a BS cannot dynamically enable or disable the HARQ-ACK feedback or indicate the HARQ-ACK feedback option to be adopted from the aforementioned three options per UE basis. For example, a BS may enable UE-specific ACK/NACK feedback for all the UEs in a multicast group at the beginning. At a certain time, the BS may want to schedule some UEs to adopt UE-specific NACK-only feedback while the remaining UEs to continue to adopt UE-specific ACK/NACK feedback. Or the BS may want to schedule some UEs to adopt UE-specific NACK-only feedback and some UEs to adopt group NACK-only feedback. The BS cannot realize the above purpose via a group-common DCI.

Embodiments of the present disclosure provide solutions to solve the above issues. More details on the embodiments of the present disclosure will be illustrated in the following text in combination with the appended drawings.

In some embodiments of the present disclosure, for a group of UEs receiving a multicast service from a BS, a common PUCCH resource pool may be configured for the group of UEs. The PUCCH resource pool may include a plurality of PUCCH resources, each of which can be used for transmitting a single bit of information, for example, an ACK or NACK.

A group-common PDCCH may indicate a HARQ-ACK feedback mode corresponding to a multicast transmission (e.g., a group-common PDSCH) scheduled by the group-common PDCCH. For example, a HARQ-ACK feedback mode indication (HFI) may be carried in a DCI format with a CRC scrambled by a group-common RNTI and may indicate a HARQ-ACK feedback mode for the multicast transmission from a plurality of HARQ-ACK feedback modes. The plurality of HARQ-ACK feedback modes may include at least one of: Mode 1—Group NACK-only feedback; Mode 2—UE-specific NACK-only feedback; Mode 3—UE-specific ACK/NACK feedback; and Mode 4—no HARQ-ACK feedback. In some examples, the DCI format may include a two-bit field for indicating the HARQ-ACK feedback mode for the scheduled multicast transmission.

In some embodiments of the present disclosure, the BS may determine the HARQ-ACK feedback mode indicated in the DCI format based on at least one of: a QoS of the multicast transmission, the number of UEs in the group of UEs, and the number of PUCCH resources in the PUCCH resource pool. The following text further exemplifies several HARQ-ACK feedback mode determination mechanism and PUCCH resource allocation mechanisms for the BS to determine the HARQ-ACK feedback mode and the member UEs to determine the PUCCH resources according to the indicated HFI.

In some embodiments, in response to the number of UEs in the group of UEs being larger than the number of PUCCH resources in the PUCCH resource pool, the BS may indicate Mode 1 in the DCI format for enabling group NACK-only feedback. This could reduce PUCCH overhead. Accordingly, at the UE side, when the HFI indicates Mode 1, the UE may determine a predefined PUCCH resource in the PUCCH resource pool for transmitting the HARQ-ACK feedback for the multicast transmission. That is, the predefined PUCCH resource is used as the common PUCCH resource for the NACK-only transmission. The predefined PUCCH resource is shared among the UEs in the group of the UEs, and can be any PUCCH resource in the PUCCH resource pool. For example, the predefined PUCCH resource may be the first or the last PUCCH resource in the pool, or other PUCCH resource which can be explicitly indicated by configuration information or implicitly determined based on a predefined equation. The BS may receive the HARQ-ACK feedback for the multicast transmission on the predefined PUCCH resource.

In some embodiments, in response to the number of UEs in the group of UEs (hereinafter denoted as “N”) being smaller than or equal to the number of PUCCH resources in the PUCCH resource pool (hereinafter denoted as “M”), the BS may indicate Mode 2 in the DCI format for enabling UE-specific NACK-only feedback.

From the UE's perspective, when the HFI indicates Mode 2, a UE may select a UE-specific PUCCH resource in the configured PUCCH resource pool for NACK-only transmission. In some examples, the UE may select the UE-specific PUCCH resource based on the UE's member ID. The member ID may be assigned to the UE when the UE joins the group of UEs and may be unique to each UE in the group of UEs. For instance, the UE may select the UE-specific PUCCH resource from the PUCCH resource pool based on a modular operation of (“member ID” mod M).

In some examples, the above modular operation may not be needed when the BS can guarantee that the number of UEs in the group is not larger than the number of PUCCH resources. In these examples, the member ID of each UE can be regarded as a PUCCH resource index corresponding to a UE-specific PUCCH resource among the PUCCH resource pool.

Other methods for determining the UE-specific PUCCH resource that can be conceived of by persons skilled in the art can also be employed. In this way, every member UE may determine a different PUCCH resource in the PUCCH resource pool since N is smaller than or equal to M. That is, every member UE can determine an orthogonal PUCCH resource. Accordingly, the BS can identify which UE sends a NACK in response to the multicast transmission.

In some embodiments, in response to the number of UEs in the group of UEs being larger than the number of PUCCH resources in the PUCCH resource pool, the BS may indicate Mode 2 in the DCI format for enabling UE-specific NACK-only feedback. A UE may employ the same method as described above to determine the PUCCH resource for the NACK-only transmission. For example, the UE may select the UE-specific PUCCH resource based on the UE's member ID. In these embodiments, some member UEs may share the same PUCCH resource since N is larger than M. Due to the PUCCH resource sharing among the member UEs, a BS cannot identify which of the member UEs sharing the same PUCCH resource fails to receive the multicast transmission when a NACK is transmitted on the shared PUCCH resource. The BS may presume that none of these member UEs successfully receive the multicast transmission. However, compared to Mode 1, Mode 2 can locate a relatively small set of UEs sharing the same PUCCH resource, rather than all UEs in the group. Thus, a PTP based retransmission can be applied to these member UEs.

In some embodiments, in response to the number of UEs in the group of UEs being smaller than or equal to a half of the number of PUCCH resources in the PUCCH resource pool, the BS may indicate Mode 3 in the DCI format for enabling UE-specific ACK/NACK feedback. In these embodiments, the BS can identify which UE sends an ACK or NACK in response to the multicast transmission.

From the UE's perspective, when the HFI indicates Mode 3, a UE may select a UE-specific PUCCH resource pair in the configured PUCCH resource pool for ACK/NACK transmission. The UE-specific PUCCH resource pair may include two PUCCH resources, one for transmitting an ACK and the other for transmitting a NACK. In some examples, the UE may select the UE-specific PUCCH resource pair based on the UE's member ID.

For instance, in some embodiments, every two consecutive PUCCH resources in the configured PUCCH resource pool may be paired as a PUCCH resource pair. Denoting the number of PUCCH resource pairs in the PUCCH resource pool as “P,” the UE may select the UE-specific PUCCH resource pair from the P PUCCH resource pairs based on the UE's member ID. For example, the UE may select the UE-specific PUCCH resource pair based on a modular operation of (“member ID” mod P).

In some embodiments, PUCCH resources in the configured PUCCH resource pool may be divided into two sub-pools. For example, the first half of the PUCCH resources in the PUCCH resource pool may form the first sub-pool and the remaining PUCCH resources in the PUCCH resource pool may form the second sub-pool. The UE may select a respective PUCCH resource from each of the two sub-pools based on the UE's member ID. For example, the UE may select a PUCCH resource from the first sub-pool based on a modular operation of (“member ID” mod “number of PUCCH resources in the first sub-pool”). The UE may select another PUCCH resource from the second sub-pool based on a modular operation of (“member ID” mod “number of PUCCH resources in the second sub-pool”).

In some examples, the above modular operation may not be needed when the BS can guarantee the number of UEs in the group is not larger than the number of PUCCH resource pairs. In this way, the member ID of each UE can be regarded as a PUCCH resource pair index corresponding to a UE-specific PUCCH resource pair. Other methods for determining the UE-specific PUCCH resource pair that can be conceived of by persons skilled in the art can also be employed.

In some embodiments, in response to the number of UEs in the group of UEs being larger than a half of the number of PUCCH resources in the PUCCH resource pool, the BS may indicate Mode 3 in the DCI format for enabling UE-specific ACK/NACK feedback. In these embodiments, some UEs may share the same PUCCH resource pair. Thus, the BS cannot identify a specific UE from the UEs sharing the same PUCCH resource pair when an ACK or NACK is transmitted on the shared PUCCH resource pair. The BS may presume that none of these UEs successfully receive the multicast transmission in response to a NACK being detected on the shared PUCCH resource pair. However, compared to Mode 1, Mode 3 can locate a relatively small set of UEs sharing the same PUCCH resource pair, rather than all UEs in the group. Thus, a PTP based retransmission can be applied to these UEs.

In some embodiments, in response to the QoS of the multicast service being low in a reliability requirement or the number of UEs in the group being larger (e.g., far large) than the number of PUCCH resources in the PUCCH resource pool, the BS may indicate Mode 4 for disabling HARQ-ACK feedback. By indicating Mode 4, the BS does not expect to receive any HARQ-ACK feedback for the multicast transmission from the group of UEs. From the UE's perspective, when the HFI indicates Mode 4, a UE may not transmit any HARQ-ACK feedback for the multicast transmission to the BS.

In some embodiments of the present disclosure, for a group of UEs receiving multicast service, each UE may be configured with a respective UE-specific PUCCH resource set for the multicast transmission by a BS. From the BS's perspective, it may determine a plurality of PUCCH resource sets for the group of UEs based on certain criteria, and may transmit the respective UE-specific PUCCH resource set selected from the plurality of PUCCH resource sets to each of the group of UEs.

When determining the plurality of PUCCH resource sets, the BS may make full use of the available PUCCH resources while maximizing the efficiency of the HARQ-ACK feedback. In some embodiments, the BS may determine the plurality of PUCCH resource sets based on the following principle: among PUCCH resources available for the multicast transmission, firstly maximizing PUCCH resource pairs for UE-specific ACK/NACK feedback, and then maximizing PUCCH resources for UE-specific NACK-only feedback. Examples for determining the plurality of PUCCH resource sets will be described in the following text.

Each UE-specific PUCCH resource set of the plurality of PUCCH resource sets may include at least one of: a PUCCH resource pair for UE-specific ACK/NACK feedback (hereinafter, “element A”), a PUCCH resource for UE-specific NACK-only feedback (hereinafter, “element B”), a PUCCH resource for group NACK-only feedback (hereinafter, “element C”); and an indicator for disabling HARQ-ACK feedback for the multicast transmission (hereinafter, “element D”). The indicator for disabling the HARQ-ACK feedback may indicate “reserved”, “not available” (or “NA”), or “no PUCCH resource.” Each PUCCH resource in the PUCCH resource set can be used for transmitting a single bit of information, for example, an ACK or a NACK. A PUCCH resource pair may include two PUCCH resources, one for transmitting an ACK and another for transmitting a NACK. In some examples, each UE-specific PUCCH resource set may include three entries corresponding to elements A-C, four entries corresponding to elements A-D, or any other combination of elements A-D.

In some embodiments of the present disclosure, a group-common PDCCH may indicate, from the configured UE-specific PUCCH resource set, a PUCCH resource corresponding to the multicast transmission (e.g., a group-common PDSCH) scheduled by the group-common PDCCH. For example, a PUCCH resource indication (PRI) may be carried in a DCI format with a CRC scrambled by a group-common RNTI and may indicate a PUCCH resource from the UE-specific PUCCH resource set. The PRI may be determined based on at least one of: a QoS of the multicast transmission, a number of UEs in the group of UEs, and a number of PUCCH resources available for the multicast transmission. The PRI may include two bits, and indicate an entry of the UE-specific PUCCH resource set.

In the above embodiments, since the PRI is carried in the group-common PDCCH, every UE in the group of UEs may receive the same PRI value, and may select the entry having the same index (hereinafter referred to as “the same entry”) from the corresponding UE-specific PUCCH resource set. For example, assuming that the PRI indicates “00,” every UE in the group of UEs may select the first entry in the corresponding UE-specific PUCCH resource set. However, the same entries of different UE-specific PUCCH resource sets for different member UEs may correspond to different elements. For example, for UE #1, the first entry may correspond to element A while for UE #2, the first entry may correspond to element D. In other words, for the UEs in the same group, different UEs may be configured with different orders of elements A, B, C, and D. For example, UE #1 may be configured with a UE-specific PUCCH resource set of {A, B, C, D} while UE #2 may be configured with a UE-specific PUCCH resource set of {D, B, C, A}. As a principle, the BS should ensure that the number of required orthogonal PUCCH resources for the same entry for the group of UEs does not exceed the number of available PUCCH resources for the multicast transmission.

In this way, although the PRI is indicated in the group-common PDCCH, it can indicate entries corresponding to different elements for different UEs. Accordingly, the BS can flexibly and dynamically adjust per UE HARQ-ACK feedback scheme based on at least one of: the QoS of the multicast service, the number of UEs in the group, and the number of PUCCH resources available for the multicast service.

In some embodiments, assuming that there are X PUCCH resources available for the multicast service and each PUCCH resource can be used for transmitting a single bit of ACK or NACK, in the case that X is an even number, there are a maximum of X/2 PUCCH resource pairs. Therefore, the X PUCCH resources can support X/2 UEs working in a UE-specific ACK/NACK feedback mode or X UEs working in a UE-specific NACK-only feedback mode. Hence, for member UEs in a group of UEs receiving the multicast service, a maximum of X/2 UEs can be configured with element A in the same entry, max X UEs can be configured with element B in the same entry. Furthermore, any number UEs can be configured with element C in the same entry, and any number UEs can be configured with element D in the same entry.

Assuming there are Y UEs in the group, based on the above principle for determining the plurality of PUCCH resource sets, an exemplary configuration can be expressed by the following pseudo code:

```
If Y <= X/2 then
  all the Y UEs can be configured with element A in the same entry;
If X/2 < Y <= X, then
  all the Y UEs can be configured with element B in the same entry;
Else
  select one option from below:
    Option 1: all the Y UEs can be configured with element C or D in the
        same entry;
    Option 2: X/2 UEs of the Y UEs are configured with element A in the
        same entry while the remaining UEs are configured with element
        D; and
    Option 3: X UEs of the Y UEs are configured with element B in the same
      entry while the remaining UEs are configured with element D.
End
```

Assuming that 8 PUCCH resources (denoted as P1˜P8) are available for a multicast service, Table 1 below shows examples of PUCCH resource sets for a group of UEs receiving the multicast service. It should be understood that Table 1 is only for illustrative purposes, and should not be construed as limiting the embodiments of the present disclosure.

TABLE 1
Examples of PUCCH resource sets

| | 1^{st} | 2^{nd} | 3^{rd} | 4^{th} |
|---|---|---|---|---|
| UE | entry | entry | entry | entry |
| UE1 | {P1, P2} | P1 | P1 | NA |
| UE2 | {P3, P4} | P3 | P1 | NA |
| UE3 | {P5, P6} | P5 | P1 | NA |
| UE4 | {P7, P8} | P7 | P1 | NA |
| UE5 | NA | P2 | P1 | {P1, P2} |
| UE6 | NA | P4 | P1 | {P3, P4} |
| UE7 | NA | P6 | P1 | {P5, P6} |
| UE8 | NA | P8 | P1 | {P7, P8} |
| UE9 | NA | NA | P1 | NA |

Since there are 8 PUCCH resources for the multicast service, when four UEs (denoted as UE1 to UE4) are in the group of UEs, all four UEs can be configured with element A in the first entry. All four UEs can be configured with element B in the second entry; all four UEs can be configured with element C in the third entry, and all four UEs can be configured with element D in the fourth entry. For example, according to Table 1, UE2 can be configured with a UE-specific PUCCH resource set of {{P3, P4}, P3, P1, NA}, wherein {P3, P4} is the PUCCH resource pair for UE-specific ACK/NACK feedback, P3 is the PUCCH resource for UE-specific NACK-only feedback, P1 is the PUCCH resource for group NACK-only feedback, and NA indicates that the HARQ-ACK feedback should be disabled at the UE.

When other four UEs (denoted as UE5 to UE8) join the group of UEs, UE5 to UE8 may be configured with element D in the first entry since all 8 available PUCCH resources are allocated to UE1 to UE4. In some examples, in the second entry, UE5 to UE8 can be configured with element B; in the third entry, UE5 to UE8 can be configured with element C; and in the fourth entry, UE5 to UE8 can be configured with element A. When more UEs (e.g., UE9) join the group, the new UEs may be configured with a UE-specific PUCCH resource set of {D, D, C, D} due to resource limitations. For example, according to Table 1. UE9 can be configured with a UE-specific PUCCH resource set of {NA, NA, P1, NA}, wherein NA indicates that the HARQ-ACK feedback should be disabled at the UE, and P1 is the PUCCH resource for group NACK-only feedback.

In some other examples, UE9 may be configured with a UE-specific PUCCH resource set of {D, B, C, D}. For example, UE9 may be configured with {NA, P1, P1, NA}), where UE1 and UE9 share the same PUCCH resources in their second entries. Due to the PUCCH resource sharing between UE1 and UE9, the BS cannot identify which of UE1 and UE9 fails to receive the multicast transmission when a NACK is transmitted on P1. The BS may presume that neither UE1 nor UE9 successfully receives the multicast transmission and may perform a PTP based retransmission to these UEs.

In some embodiments, assuming that there are X+1 PUCCH resources available for the multicast service and each PUCCH resource can be used for transmitting a single bit of ACK or NACK, in the case that X is an even number, there are a maximum of X/2 PUCCH resource pairs. Therefore, the X+1 PUCCH resources can support X/2 UEs working in the UE-specific ACK/NACK feedback mode or X+1 UEs working in UE-specific NACK-only feedback mode. Hence, for member UEs in a group of UEs receiving the multicast service, a maximum of X/2 UEs can be configured with element A in the same entry, max X+1 UEs can be configured with element B in the same entry. Furthermore, any number UEs can be configured with element C in the same entry, and any number UEs can be configured with element D in the same entry.

Assuming there are Y UEs in the group, based on the above principle for determining the plurality of PUCCH resource sets, an exemplary configuration can be expressed by the following pseudo code:

```
If Y <= X/2 then
  all the Y UEs can be configured with element A in the same entry;
If X/2 < Y <= X, then
    select one option from below:
        Option 1: all the Y UEs can be configured with element B in the
  same entry;
          Option 2: X/2 UEs of the Y UEs are configured with element A in
          the same entry while the remaining UEs are configured with
          element C or D;
Else
    select one option from below:
      Option 1: all the Y UEs can be configured with element C or D in the
          same entry;
      Option 2: X/2 UEs of the Y UEs are configured with element A in the
          same entry while the remaining UEs are configured with element C
          or D;
      Option 3: X UEs of the Y UEs are configured with element B in the same
          entry while the remaining UEs are configured with element C or
          D;
      Option 4: X+1 UEs of the Y UEs are configured with element B in the
          same entry while the remaining UEs are configured with element
          D;
End
```

Assuming that 9 PUCCH resources (denoted as P0˜P8) are available for a multicast service, Table 2 below shows examples of PUCCH resource sets for a group of UEs receiving the multicast service. It should be understood that Table 2 is only for illustrative purposes, and should not be construed as limiting the embodiments of the present disclosure.

TABLE 2
Examples of PUCCH resource sets

| | 1^{st} | 2^{nd} | 3^{rd} | 4^{th} |
|---|---|---|---|---|
| UE | entry | entry | entry | entry |
| UE1 | {P1, P2} | P1 | P0 | P0 or NA |
| UE2 | {P3, P4} | P3 | P0 | P0 or NA |
| UE3 | {P5, P6} | P5 | P0 | P0 or NA |
| UE4 | {P7, P8} | P7 | P0 | P0 or NA |
| UE5 | P0 or NA | P2 | P0 | {P1, P2} |
| UE6 | P0 or NA | P4 | P0 | {P3, P4} |
| UE7 | P0 or NA | P6 | P0 | {P5, P6} |
| UE8 | P0 or NA | P8 | P0 | {P7, P8} |
| UE9 | P0 or NA | P0 or NA | P0 | P0 or NA |

Since there are 9 PUCCH resources for the multicast service, when four UEs (denoted as UE1 to UE4) are in the group of UEs, all four UEs can be configured with element A in the first entry. All four UEs can be configured with element B in the second entry; all four UEs can be configured with element C in the third entry, and all four UEs can be configured with element C or element D in the fourth entry. For example, according to Table 2, UE1 can be configured with a UE-specific PUCCH resource set of {{P1, P2}, P1, P0, P0} or {{P1, P2}, P1, P0, NA}, wherein {P1, P2} is the PUCCH resource pair for UE-specific ACK/NACK feedback, P1 indicated by the second entry is the PUCCH resource for UE-specific NACK-only feedback, P0 indicated by the third or fourth entry is the PUCCH resource for group NACK-only feedback, and NA indicates that the HARQ-ACK feedback should be disabled at the UE.

When other four UEs (denoted as UE5 to UE8) join the group of UEs, UE5 to UE8 may have to be configured with element C or D in the first entry since 8 of the 9 available PUCCH resources are allocated to UE1 to UE4. In the second entry, UE5 to UE8 can be configured with element B; in the third entry, UE5 to UE8 can be configured with element C; and in the fourth entry, UE5 to UE8 can be configured with element A. When more UEs (e.g., UE9) join the group, the new UEs may have to be configured with a UE-specific PUCCH resource set of {C/D, C/D, B/C, C/D} due to resource limitations.

In some embodiments, the PUCCH resource sets may not include element D. Table 3 below shows examples of such PUCCH resource sets for a group of UEs receiving the multicast service. It should be understood that Table 3 is only for illustrative purposes, and should not be construed as limiting the embodiments of the present disclosure.

TABLE 3
Examples of PUCCH resource sets

| | 1^{st} | 2^{nd} | 3^{rd} |
|---|---|---|---|
| UE | entry | entry | entry |
| UE1 | {P1, P2} | P1 | P0 |
| UE2 | {P3, P4} | P3 | P0 |
| UE3 | {P5, P6} | P5 | P0 |
| UE4 | {P7, P8} | P7 | P0 |
| UE5 | P0 | P2 | {P1, P2} |
| UE6 | P0 | P4 | {P3, P4} |
| UE7 | P0 | P6 | {P5, P6} |
| UE8 | P0 | P8 | {P7, P8} |
| UE9 | P0 | P0 | P0 |

As shown in Table 3, each PUCCH resource set includes 3 entries without element D for disabling the HARQ-ACK feedback. Assuming 9 PUCCH resources (denoted as P0˜P8) are available for the multicast service, when four UEs (denoted as UE1 to UE4) are in the group of UEs, all four UEs can be configured with element A in the first entry. All four UEs can be configured with element B in the second entry; all four UEs can be configured with element C in the third entry.

When other four UEs (denoted as UE5 to UE8) join the group of UEs, UE5 to UE8 may be configured with element C in the first entry since 8 of the 9 available PUCCH resources are allocated to UE1 to UE4. In the second entry, UE5 to UE8 can be configured with element B; and in the third entry, UE5 to UE8 can be configured with element A. When more UEs (e.g., UE9) join the group, the new UEs may have to be configured with a UE-specific PUCCH resource set of {C, B/C, C} due to resource limitations.

In some embodiments of the present disclosure, instead of using the group-common PDCCH for carrying the PRI, a RRC signaling message, a medium access control (MAC) control element (CE), or a DCI format with a CRC scrambled by a UE-specific RNTI may be used to carry the PRI. The MAC CE may be carried in a group-common PDSCH or a UE-specific PDSCH. In this way, different UEs can receive different PRI values. The descriptions with respect to the embodiments in which the PRI is carried by the group-common PDCCH can be applied here, except that in these embodiments, the BS does not necessarily need to ensure that the number of required orthogonal PUCCH resources for the same entry for the group of UEs does not exceed the number of available PUCCH resources for the multicast transmission. However, for the same multicast PDSCH, the BS should ensure the number of required orthogonal PUCCH resources for the group of UEs does not exceed the number of available PUCCH resources for the multicast transmission. In this way, the BS can flexibly and dynamically adjust per UE HARQ-ACK feedback scheme based on at least one of: the QoS of the multicast service, the number of UEs in the group, and the number of PUCCH resources available for the multicast service.

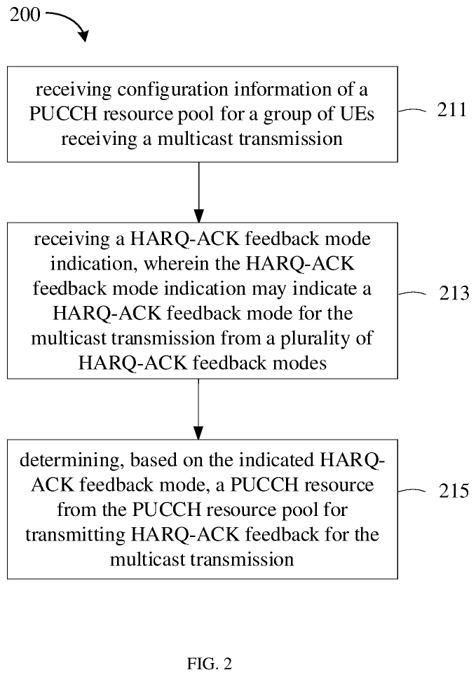

FIG. 2 illustrates a flow chart of an exemplary procedure 200 for wireless communications in accordance with some embodiments of the present disclosure. Details described in all of the foregoing embodiments of the present disclosure are applicable for the embodiments shown in FIG. 2. In some examples, the procedure may be performed by a UE, for example, UE 101 in FIG. 1.

Referring to FIG. 2, in operation 211, a UE may receive configuration information of a PUCCH resource pool for a group of UEs receiving a multicast transmission. The group of UEs includes the UE. The PUCCH resource pool is a common resource pool shared by the group of UEs. Each PUCCH resource in the PUCCH resource pool may carry one bit of ACK or NACK.

In operation 213, the UE may receive a HARQ-ACK feedback mode indication. The HARQ-ACK feedback mode indication may indicate a HARQ-ACK feedback mode for the multicast transmission from a plurality of HARQ-ACK feedback modes.

In some embodiments, the indicated HARQ-ACK feedback may be based on at least one of: a QoS of the multicast transmission, a number of UEs in the group of UEs, and a number of PUCCH resources in the PUCCH resource pool. In some embodiments, the HARQ-ACK feedback mode indication may be carried in a DCI format, which schedules the multicast transmission with CRC bits scrambled by an RNTI common to the group of UEs.

In some embodiments, the plurality of HARQ-ACK feedback modes may include at least one of: a first HARQ-ACK feedback mode indicating group NACK-only feedback; a second HARQ-ACK feedback mode indicating UE-specific NACK-only feedback; a third HARQ-ACK feedback mode indicating UE-specific ACK/NACK feedback; and a fourth HARQ-ACK feedback mode indicating no HARQ-ACK feedback.

In operation 215, the UE may determine, based on the indicated HARQ-ACK feedback mode, a PUCCH resource from the PUCCH resource pool for transmitting HARQ-ACK feedback for the multicast transmission.

In some embodiments, determining the PUCCH resource from the PUCCH resource pool for transmitting the HARQ-ACK feedback for the multicast transmission may include: (1) determining a predefined PUCCH resource in the PUCCH resource pool for transmitting the HARQ-ACK feedback for the multicast transmission in response to the indicated HARQ-ACK feedback mode being the first HARQ-ACK feedback mode; (2) determining a UE-specific PUCCH resource in the PUCCH resource pool for transmitting the HARQ-ACK feedback for the multicast transmission based on a member ID of the UE in response to the indicated HARQ-ACK feedback mode being the second HARQ-ACK feedback mode; (3) determining a UE-specific PUCCH resource pair in the PUCCH resource pool for transmitting the HARQ-ACK feedback for the multicast transmission based on the member ID of the UE in response to the indicated HARQ-ACK feedback mode being the third HARQ-ACK feedback mode; and (4) determining not to transmit the HARQ-ACK feedback for the multicast transmission in response to the indicated HARQ-ACK feedback mode being the fourth HARQ-ACK feedback mode.

In some embodiments, determining the UE-specific PUCCH resource pair based on the member ID of the UE may include: pairing every two consecutive PUCCH resources in the PUCCH resource pool as a PUCCH resource pair to determine a plurality of PUCCH resource pairs, and selecting the UE-specific PUCCH resource pair from the plurality of PUCCH resource pairs based on the member ID of the UE; or dividing PUCCH resources in the PUCCH resource pool into two sub-pools, and selecting a PUCCH resource from each of the two sub-pools based on the member ID of the UE as the UE-specific PUCCH resource pair.

It should be appreciated by persons skilled in the art that the sequence of the operations in exemplary procedure 200 may be changed and some of the operations in exemplary procedure 200 may be eliminated or modified, without departing from the spirit and scope of the disclosure.

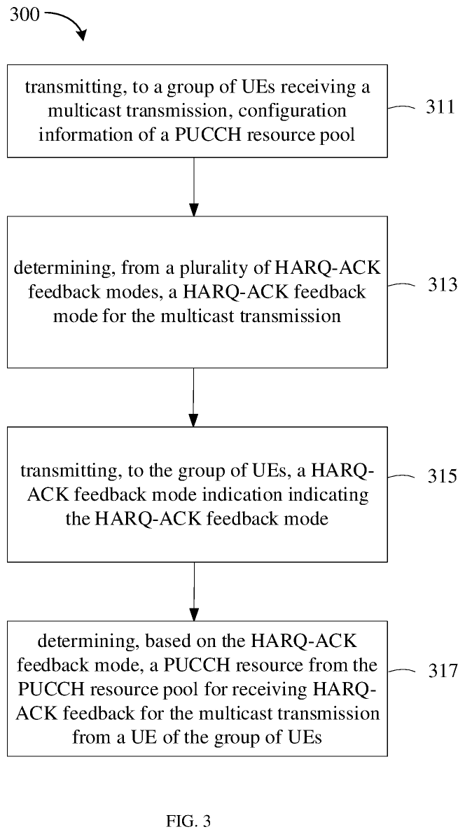

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a BS, for example, BS 102 in FIG. 1.

Referring to FIG. 3, in operation 311, a BS may transmit, to a group of UEs receiving a multicast transmission, configuration information of a PUCCH resource pool. The PUCCH resource pool is a common PUCCH resource pool shared by the group of UEs. Each PUCCH resource in the PUCCH resource pool may carry one bit of ACK or NACK.

In operation 313, the BS may determine, from a plurality of HARQ-ACK feedback modes, a HARQ-ACK feedback mode for the multicast transmission. In some embodiments, the HARQ-ACK feedback mode for the multicast transmission may be determined based on at least one of: a quality of service (QOS) of the multicast transmission, a number of UEs in the group of UEs, and a number of PUCCH resources in the PUCCH resource pool.

In some embodiments, the plurality of HARQ-ACK feedback modes may include at least one of: a first HARQ-ACK feedback mode indicating group NACK-only feedback; a second HARQ-ACK feedback mode indicating UE-specific NACK-only feedback; a third HARQ-ACK feedback mode indicating UE-specific ACK/NACK feedback; and a fourth HARQ-ACK feedback mode indicating no HARQ-ACK feedback.

In some embodiments, determining the HARQ-ACK feedback mode for the multicast transmission from a plurality of HARQ-ACK feedback modes may include at least one of: determining the first, second, or the fourth HARQ-ACK feedback mode as the HARQ-ACK feedback mode for the multicast transmission in response to a number of UEs in the group of UEs being larger than a number of PUCCH resources in the PUCCH resource pool; determining the second HARQ-ACK feedback mode as the HARQ-ACK feedback mode for the multicast transmission in response to the number of UEs in the group of UEs being smaller than or equal to the number of PUCCH resources in the PUCCH resource pool; determining the third HARQ-ACK feedback mode as the HARQ-ACK feedback mode for the multicast transmission in response to the number of UEs in the group of UEs being smaller than or equal to a half of the number of PUCCH resources in the PUCCH resource pool; determining the third HARQ-ACK feedback mode as the HARQ-ACK feedback mode for the multicast transmission in response to the number of UEs in the group of UEs being larger than the half of the number of PUCCH resources in the PUCCH resource pool; and determining the fourth HARQ-ACK feedback mode as the HARQ-ACK feedback mode for the multicast transmission in response to a QoS of the multicast transmission being low.

In operation 315, the BS may transmit, to the group of UEs, a HARQ-ACK feedback mode indication indicating the HARQ-ACK feedback mode. In some embodiments, the HARQ-ACK feedback mode indication may be carried in a DCI format, which schedules the multicast transmission with CRC bits scrambled by an RNTI common to the group of UEs.

In operation 317, the BS may determine, based on the HARQ-ACK feedback mode, a PUCCH resource from the PUCCH resource pool for receiving HARQ-ACK feedback for the multicast transmission from a UE of the group of UEs.

In some embodiments, determining the PUCCH resource from the PUCCH resource pool for receiving the HARQ-ACK feedback for the multicast transmission from the UE of the group of UEs may include: determining a predefined PUCCH resource in the PUCCH resource pool for receiving the HARQ-ACK feedback for the multicast transmission in response to the HARQ-ACK feedback mode being the first HARQ-ACK feedback mode; determining a UE-specific PUCCH resource in the PUCCH resource pool for receiving the HARQ-ACK feedback for the multicast transmission based on a member ID of the UE in response to the HARQ-ACK feedback mode being the second HARQ-ACK feedback mode; determining a UE-specific PUCCH resource pair in the PUCCH resource pool for receiving the HARQ-ACK feedback for the multicast transmission based on the member ID of the UE in response to the HARQ-ACK feedback mode being the third HARQ-ACK feedback mode; and determining not to receive any HARQ-ACK feedback for the multicast transmission from the UE in response to the HARQ-ACK feedback mode being the fourth HARQ-ACK feedback mode.

In some embodiments, determining the UE-specific PUCCH resource pair based on a member ID of the UE may include: pairing every two consecutive PUCCH resources in the PUCCH resource pool as a PUCCH resource pair to determine a plurality of PUCCH resource pairs, and selecting the UE-specific PUCCH resource pair from the plurality of PUCCH resource pairs based on the member ID of the UE; or dividing PUCCH resources in the PUCCH resource pool into two sub-pools, and selecting a PUCCH resource from each of the two sub-pools based on the member ID of the UE as the UE-specific PUCCH resource pair.

It should be appreciated by persons skilled in the art that the sequence of the operations in exemplary procedure 300 may be changed and some of the operations in exemplary procedure 300 may be eliminated or modified, without departing from the spirit and scope of the disclosure.

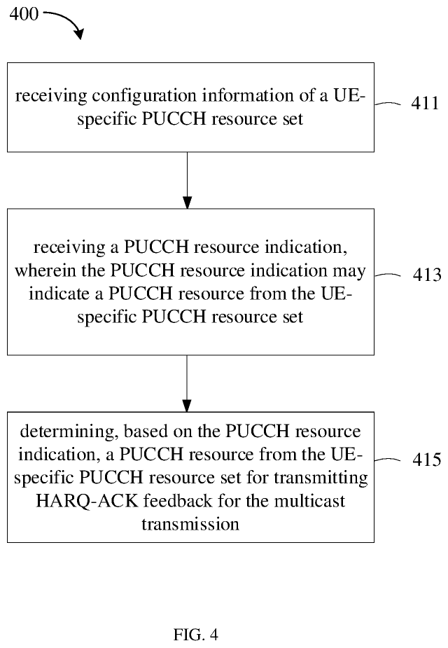

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 101 in FIG. 1.

Referring to FIG. 4, in operation 411, a UE may receive configuration information of a UE-specific PUCCH resource set. The UE-specific PUCCH resource set may be from a plurality of PUCCH resource sets which are configured for a group of UEs receiving a multicast transmission. The group of UEs may include the UE. Each PUCCH resource in the UE-specific PUCCH resource set may carry one bit of ACK or NACK.

In some embodiments, each PUCCH resource set of the plurality of PUCCH resource sets may include at least one of: a PUCCH resource for group NACK-only feedback; a PUCCH resource for UE-specific NACK-only feedback; a PUCCH resource pair for UE-specific ACK/NACK feedback; and an indicator for disabling HARQ-ACK feedback for the multicast transmission. In some embodiments, the plurality of PUCCH resource sets may be determined by, among PUCCH resources available for the multicast transmission, firstly maximizing PUCCH resource pairs for UE-specific ACK/NACK feedback, and then maximizing PUCCH resources for UE-specific NACK-only feedback.

In operation 413, the UE may receive a PUCCH resource indication. The PUCCH resource indication may indicate a PUCCH resource from the UE-specific PUCCH resource set.

In some embodiments, the PUCCH resource indication may be carried in one of: a DCI format which schedules the multicast transmission with CRC bits scrambled by an RNTI common to the group of UEs; a RRC signaling message; a MAC CE; and a DCI format with CRC bits scrambled by an RNTI specific to the UE. In some embodiments, the PUCCH resource indication may be determined based on at least one of: a QoS of the multicast transmission, a number of UEs in the group of UEs, and a number of PUCCH resources available for the multicast transmission.

In operation 415, the UE may determine, based on the PUCCH resource indication, a PUCCH resource from the UE-specific PUCCH resource set for transmitting HARQ-ACK feedback for the multicast transmission.

It should be appreciated by persons skilled in the art that the sequence of the operations in exemplary procedure 400 may be changed and some of the operations in exemplary procedure 400 may be eliminated or modified, without departing from the spirit and scope of the disclosure.

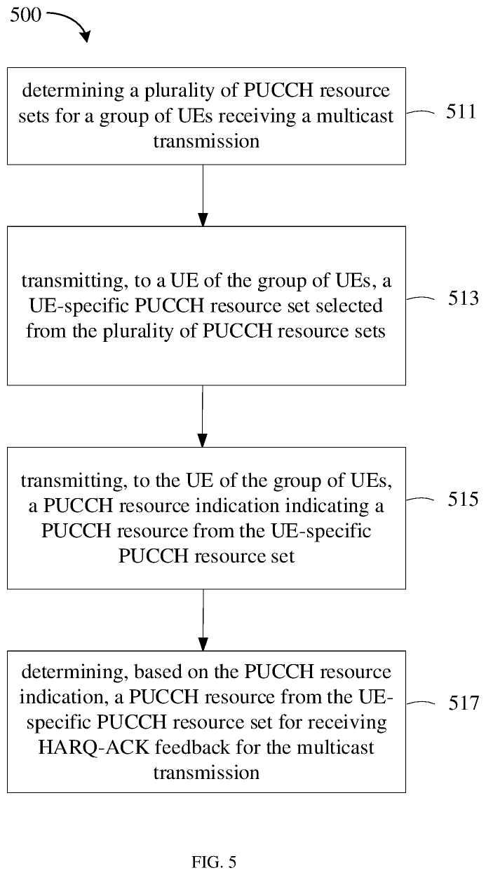

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a BS, for example, BS 102 in FIG. 1.

Referring to FIG. 5, in operation 511, a BS may determine a plurality of PUCCH resource sets for a group of UEs receiving a multicast transmission. In some embodiments, each PUCCH resource set of the plurality of PUCCH resource sets may include at least one of: a PUCCH resource for group NACK-only feedback; a PUCCH resource for UE-specific NACK-only feedback; a PUCCH resource pair for UE-specific ACK/NACK feedback; and an indicator for disabling HARQ-ACK feedback for the multicast transmission.

In some embodiments, determining the plurality of PUCCH resource sets for the group of UEs may include: among PUCCH resources available for the multicast transmission, firstly maximizing PUCCH resource pairs for UE-specific ACK/NACK feedback, and then maximizing PUCCH resources for UE-specific NACK-only feedback.

In operation 513, the BS may transmit, to a UE of the group of UEs, a UE-specific PUCCH resource set selected from the plurality of PUCCH resource sets. Each PUCCH resource in the UE-specific PUCCH resource set may carry one bit of ACK or NACK.

In operation 515, the BS may transmit, to the UE of the group of UEs, a PUCCH resource indication indicating a PUCCH resource from the UE-specific PUCCH resource set.

In some embodiments, the PUCCH resource indication may be carried in one of: a DCI format which schedules the multicast transmission with CRC bits scrambled by an RNTI common to the group of UEs; a RRC signaling message; a MAC CE; and a DCI format with CRC bits scrambled by an RNTI specific to the UE. In some embodiments, the PUCCH resource indication may be determined based on at least one of: a QoS of the multicast transmission, a number of UEs in the group of UEs, and a number of PUCCH resources available for the multicast transmission.

In operation 517, the BS may determine, based on the PUCCH resource indication, a PUCCH resource from the UE-specific PUCCH resource set for receiving HARQ-ACK feedback for the multicast transmission.

It should be appreciated by persons skilled in the art that the sequence of the operations in exemplary procedure 500 may be changed and some of the operations in exemplary procedure 500 may be eliminated or modified, without departing from the spirit and scope of the disclosure.

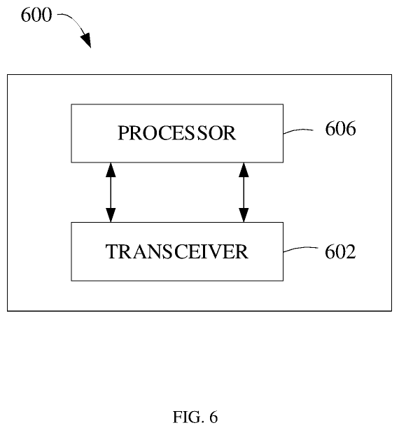

FIG. 6 illustrates a block diagram of an exemplary apparatus 600 according to some embodiments of the present disclosure.

As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described in FIGS. 1-5. In some embodiments of the present application, the apparatus 600 may be a BS. The transceiver 602 and the processor 606 may interact with each other so as to perform the operations with respect to the BS described in FIGS. 1-5.

In some embodiments of the present application, the apparatus 600 may further include at least one non-transitory computer-readable medium.

For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602, so as to perform the operations with respect to the UE described in FIGS. 1-5.

In some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A user equipment (UE) for wireless communication, comprising:
at least one memory; and
at least one processor coupled with the at least one memory and configured to cause the UE to:
receive configuration information of a physical uplink control channel (PUCCH) resource pool for a group of UEs receiving a multicast transmission, wherein the group of UEs comprises the UE;
receive a hybrid automatic repeat request acknowledgement (HARQ-ACK) feedback mode indication, wherein the HARQ-ACK feedback mode indication indicates a HARQ-ACK feedback mode for the multicast transmission from a plurality of HARQ-ACK feedback modes; and
determine, based at least in part on the indicated HARQ-ACK feedback mode, a PUCCH resource from the PUCCH resource pool for transmitting HARQ-ACK feedback for the multicast transmission.

16. The UE of claim 15, wherein the at least one processor is configured to cause the UE to determine the indicated HARQ-ACK feedback mode based on at least one of: a quality of service (QOS) of the multicast transmission, a number of UEs in the group of UEs, or a number of PUCCH resources in the PUCCH resource pool.

17. The UE of claim 15, wherein the HARQ-ACK feedback mode indication is carried in a downlink control information (DCI) format, which schedules the multicast transmission with cyclic redundancy check (CRC) bits scrambled by a radio network temporary identifier (RNTI) common to the group of UEs.

18. The UE of claim 15, wherein each PUCCH resource in the PUCCH resource pool carries one bit of acknowledgement (ACK) or negative ACK (NACK).

19. The UE of claim 15, wherein the plurality of HARQ-ACK feedback modes comprises at least one of:
a first HARQ-ACK feedback mode indicating group negative acknowledgement (NACK)-only feedback;
a second HARQ-ACK feedback mode indicating UE-specific NACK-only feedback;
a third HARQ-ACK feedback mode indicating UE-specific ACK/NACK feedback; and
a fourth HARQ-ACK feedback mode indicating no HARQ-ACK feedback.

20. The UE of claim 19, wherein to determine the PUCCH resource from the PUCCH resource pool for transmitting the HARQ-ACK feedback for the multicast transmission, the at least one processor is configured to cause the UE to:
determine a predefined PUCCH resource in the PUCCH resource pool for transmitting the HARQ-ACK feedback for the multicast transmission in response to the indicated HARQ-ACK feedback mode being the first HARQ-ACK feedback mode;
determine a UE-specific PUCCH resource in the PUCCH resource pool for transmitting the HARQ-ACK feedback for the multicast transmission based on a member ID of the UE in response to the indicated HARQ-ACK feedback mode being the second HARQ-ACK feedback mode;
determine a UE-specific PUCCH resource pair in the PUCCH resource pool for transmitting the HARQ-ACK feedback for the multicast transmission based on the member ID of the UE in response to the indicated HARQ-ACK feedback mode being the third HARQ-ACK feedback mode; and
determine not to transmit the HARQ-ACK feedback for the multicast transmission in response to the indicated HARQ-ACK feedback mode being the fourth HARQ-ACK feedback mode.

21. The UE of claim 20, wherein to determine the UE-specific PUCCH resource pair based on the member ID of the UE, the at least one processor is configured to cause the UE to one or more of:
pair each two consecutive PUCCH resources in the PUCCH resource pool as a PUCCH resource pair to determine a plurality of PUCCH resource pairs, and select the UE-specific PUCCH resource pair from the plurality of PUCCH resource pairs based on the member ID of the UE; or
divide PUCCH resources in the PUCCH resource pool into two sub-pools, and select a PUCCH resource from each of the two sub-pools based on the member ID of the UE as the UE-specific PUCCH resource pair.

22. A user equipment (UE) for wireless communication, comprising:
at least one memory; and
at least one processor coupled with the at least one memory and configured to cause the UE to:
receive configuration information of a UE-specific physical uplink control channel (PUCCH) resource set, wherein the UE-specific PUCCH resource set is from a plurality of PUCCH resource sets which are configured for a group of UEs receiving a multicast transmission, and wherein the group of UEs comprises the UE;
receive a PUCCH resource indication, wherein the PUCCH resource indication indicates a PUCCH resource from the UE-specific PUCCH resource set; and
determine, based at least in part on the PUCCH resource indication, a PUCCH resource from the UE-specific PUCCH resource set for transmitting hybrid automatic repeat request acknowledgement (HARQ-ACK) feedback for the multicast transmission.

23. The UE of claim 22, wherein the PUCCH resource indication is carried in one of:
a downlink control information (DCI) format which schedules the multicast transmission with cyclic redundancy check (CRC) bits scrambled by a radio network temporary identifier (RNTI) common to the group of UEs;
a radio resource control (RRC) signaling message;
a medium access control (MAC) control element (CE); or
a DCI format with CRC bits scrambled by an RNTI specific to the UE.

24. The UE of claim 22, wherein the at least one processor is configured to cause the UE to determine the PUCCH resource indication based on at least one of: a quality of service (QOS) of the multicast transmission, a number of UEs in the group of UEs, or a number of PUCCH resources available for the multicast transmission.

25. The UE of claim 22, wherein each PUCCH resource in the UE-specific PUCCH resource set carries one bit of acknowledgement (ACK) or negative ACK (NACK).

26. The UE of claim 22, wherein each PUCCH resource set of the plurality of PUCCH resource sets includes at least one of:
a PUCCH resource for group negative acknowledgement (NACK)-only feedback;
a PUCCH resource for UE-specific NACK-only feedback;
a PUCCH resource pair for UE-specific ACK/NACK feedback; and
an indicator for disabling HARQ-ACK feedback for the multicast transmission.

27. The UE of claim 22, wherein the at least one processor is configured to cause the UE to determine the plurality of PUCCH resource sets by, among PUCCH resources available for the multicast transmission, maximizing PUCCH resource pairs for UE-specific ACK/NACK feedback, and maximizing PUCCH resources for UE-specific NACK-only feedback.

28. A processor for wireless communication, comprising:
at least one controller coupled with at least one memory and configured to cause a the processor to:
receive configuration information of a physical uplink control channel (PUCCH) resource pool for a group of user equipment (UEs) receiving a multicast transmission, wherein the group of UEs comprises a UE;
receive a hybrid automatic repeat request acknowledgement (HARQ-ACK) feedback mode indication, wherein the HARQ-ACK feedback mode indication indicates a HARQ-ACK feedback mode for the multicast transmission from a plurality of HARQ-ACK feedback modes; and
determine, based at least in part on the indicated HARQ-ACK feedback mode, a PUCCH resource from the PUCCH resource pool for transmitting HARQ-ACK feedback for the multicast transmission.

29. The processor of claim 28, wherein the at least one controller is configured to cause the processor to determine the indicated HARQ-ACK feedback mode based on at least one of: a quality of service (QOS) of the multicast transmission, a number of UEs in the group of UEs, or a number of PUCCH resources in the PUCCH resource pool.

30. The processor of claim 28, wherein the HARQ-ACK feedback mode indication is carried in a downlink control information (DCI) format, which schedules the multicast transmission with cyclic redundancy check (CRC) bits scrambled by a radio network temporary identifier (RNTI) common to the group of UEs.

31. The processor of claim 28, wherein each PUCCH resource in the PUCCH resource pool carries one bit of acknowledgement (ACK) or negative ACK (NACK).

32. The processor of claim 28, wherein the plurality of HARQ-ACK feedback modes comprises at least one of:
a first HARQ-ACK feedback mode indicating group negative acknowledgement (NACK)-only feedback;
a second HARQ-ACK feedback mode indicating UE-specific NACK-only feedback;
a third HARQ-ACK feedback mode indicating UE-specific ACK/NACK feedback; and
a fourth HARQ-ACK feedback mode indicating no HARQ-ACK feedback.

33. The processor of claim 32, wherein to determine the PUCCH resource from the PUCCH resource pool for transmitting the HARQ-ACK feedback for the multicast transmission, the at least one controller is configured to cause the processor to:
determine a predefined PUCCH resource in the PUCCH resource pool for transmitting the HARQ-ACK feedback for the multicast transmission in response to the indicated HARQ-ACK feedback mode being the first HARQ-ACK feedback mode;
determine a UE-specific PUCCH resource in the PUCCH resource pool for transmitting the HARQ-ACK feedback for the multicast transmission based on a member ID of the UE in response to the indicated HARQ-ACK feedback mode being the second HARQ-ACK feedback mode;
determine a UE-specific PUCCH resource pair in the PUCCH resource pool for transmitting the HARQ-ACK feedback for the multicast transmission based on the member ID of the UE in response to the indicated HARQ-ACK feedback mode being the third HARQ-ACK feedback mode; and
determine not to transmit the HARQ-ACK feedback for the multicast transmission in response to the indicated HARQ-ACK feedback mode being the fourth HARQ-ACK feedback mode.

34. The UE of claim 33, wherein to determine the UE-specific PUCCH resource pair based on the member ID of the UE, the at least one controller is configured to cause the processor to one or more of:
pair each two consecutive PUCCH resources in the PUCCH resource pool as a PUCCH resource pair to determine a plurality of PUCCH resource pairs, and select the UE-specific PUCCH resource pair from the plurality of PUCCH resource pairs based on the member ID of the UE; or
divide PUCCH resources in the PUCCH resource pool into two sub-pools, and select a PUCCH resource from each of the two sub-pools based on the member ID of the UE as the UE-specific PUCCH resource pair.
